(19) United States
(12) Patent Application Publication
(10) Pub. No.: US 2014/0177937 A1
(43) Pub. Date: Jun. 26, 2014

(54) HARDNESS TESTER AND METHOD FOR HARDNESS TEST

(71) Applicant: Mitutoyo Corporation, Kanagawa (JP)

(72) Inventors: Kozo ARIGA, Tokyo (JP); Masaru KAWAZOE, Kanagawa (JP)

(73) Assignee: Mitutoyo Corporation, Kanagawa (JP)

(21) Appl. No.: 14/069,598

(22) Filed: Nov. 1, 2013

(30) Foreign Application Priority Data
Dec. 26, 2012 (JP) 2012-281955

(51) Int. Cl. G01N 3/06; G06T 7/00; G01N 3/42

(52) U.S. Cl. CPC G01N 3/068; G01N 3/42; G06T 7/0004
USPC 382/141

(57) ABSTRACT

The hardness tester includes a data obtainer obtaining sample shape data that can specify a shape of a sample; an image capture controller controlling a CCD camera to capture an image of the surface of the sample and obtaining image data of the sample; a matching performer associating the sample shape data obtained by the data obtainer with the image data of the sample obtained by the CCD camera; an indentation former forming an indentation with an indenter in a test position set on the sample shape data after the sample shape data and the image data of the sample have been associated by the matching performer; and a hardness value calculator calculating a hardness value of the sample based on the indentation captured with the CCD camera after the indentation has been formed by the indentation former.

### CROSS-REFERENCE TO RELATED APPLICATIONS

The present application claims priority under 35 U.S.C. §119 of Japanese Application No. 2012-281955, filed on Dec. 26, 2012, the disclosure of which is expressly incorporated by reference herein in its entirety.

### BACKGROUND OF THE INVENTION

1. Field of the Invention

The present invention relates to a hardness tester and a method for a hardness test.

2. Description of Related Art

Conventionally, hardness testing methods of a pressing type are well known, such as the Vickers hardness test and the Knoop hardness test, in which an indenter having a planar polygonal shape is pressed against a surface of a sample, then a hardness value of the sample is measured from a length of a diagonal line in a resulting polygonal indentation in the sample surface. Such hardness testing methods are often used in evaluating mechanical characteristics of metallic materials.

In a conventional hardness tester, there is a case where a hardness test is performed at a plurality of points, such as in evaluation of thickness of a layer hardened due to a heat treatment, (see Japanese Patent No. 4261418, for example). In such a case, first, a plurality of partial images are taken of the sample. Next, an automatic hardness test is performed at a plurality of points by determining a plurality of indentation forming positions on an image pieced together from the plurality of obtained partial images, or on an image showing the shape of the sample obtained by performing image processing on the pieced-together image and extracting a contour.

In the hardness tester, indentation is measured with a high-powered microscope. Thus, a circumstance arises where a field of view is narrowed in a process to determine an indentation forming position. Accordingly, it is necessary to obtain a wide range image of the sample in some way so that a user can understand the entire image of the sample. Thus, in general, for a test such as the evaluation of the depth of the hardened layer, there is a plan by the user about portions of the sample subjected to heat treatment for which hardness needs to be obtained, specifically CAD data showing a size of the sample or a planning map showing positions in which a hardness test is performed.

However, the conventional hardness tester does not include a component incorporating CAD data and a planning map. Thus, programming of test positions has been performed using information from a camera image of a sample. Accordingly, the above-described conventional programming method requires obtaining a wide range image of the sample, for example, and thus programming has been difficult to perform. Specifically, with the conventional hardness tester, it was impossible for a user to effectively utilize data prepared in advance, and thus a hardness test could not be efficiently performed.

### SUMMARY OF THE INVENTION

A non-limiting feature of the present invention is to provide a hardness tester and a method for a hardness test that can efficiently perform a hardness test.

An aspect of the present invention is a hardness tester measuring hardness of a sample by forming an indentation in a surface of the sample by loading a predetermined test force on an indenter and measuring a dimension of the indentation. The hardness tester includes a data obtainer obtaining sample shape data that can specify a shape of the sample; an image capture controller controlling an image capturer to capture an image of the surface of the sample and obtaining image data of the sample; a matching performer associating the sample shape data obtained by the data obtainer with the image data of the sample obtained by the image capturer; an indentation former forming the indentation with the indenter in a test position set on the sample shape data after the sample shape data and the image data of the sample have been associated by the matching performer; and a hardness value calculator calculating a hardness value of the sample based on the indentation captured with the image capturer after the indentation has been formed by the indentation former.

Another aspect of the present invention is the hardness tester, wherein the hardness tester further comprises a display controller displaying the image of the surface of the sample on a display based on the image data of the sample obtained by the image capturer.

Another aspect of the present invention is the hardness tester, wherein the display controller further displays test results on the display, based on the indentation captured by the image capturer and the hardness value of the sample calculated by the hardness value calculator.

Another aspect of the present invention is the hardness tester, wherein the hardness tester further comprises a test position setter setting the test position on the sample shape data obtained by the data obtainer.

Another aspect of the present invention is a method for a hardness test in a hardness tester measuring hardness of a sample by forming an indentation in a surface of the sample by loading a predetermined test force on an indenter and measuring a dimension of the indentation. The method for the hardness test includes data obtainment obtaining sample shape data that can specify a shape of the sample; image capture controlling an image capturer to capture an image of the surface of the sample and obtaining image data of the sample; matching associating the sample shape data obtained in the data obtainment with the image data of the sample obtained in the image capture; indentation formation forming the indentation with the indenter in a test position set on the sample shape data after the sample shape data and the image data of the sample have been associated in the matching; and hardness value calculation calculating a hardness value of the sample based on the indentation captured with the image capturer after the indentation has been formed in the indentation formation.

According to the present invention, sample shape data prepared before a test can be effectively utilized, and thus a hardness test can be efficiently performed.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating an overall configuration of a hardness tester according to the present invention;

FIG. 2 is a schematic view illustrating a hardness tester main body of the hardness tester according to the present invention;

FIG. 3 is a schematic view illustrating a hardness measurer of the hardness tester according to the present invention;

FIG. 4 is a block diagram illustrating a control structure of the hardness tester according to the present invention;

FIG. 5 is a flow chart illustrating operations of the hardness tester according to the present invention;

FIG. 6 is a diagram illustrating exemplary sample shape data of a sample;

FIG. 7 is a diagram illustrating an exemplary image of a sample surface displayed on a monitor; and

FIG. 8 is a diagram illustrating an exemplary image of the sample surface after being matched with the sample shape data.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

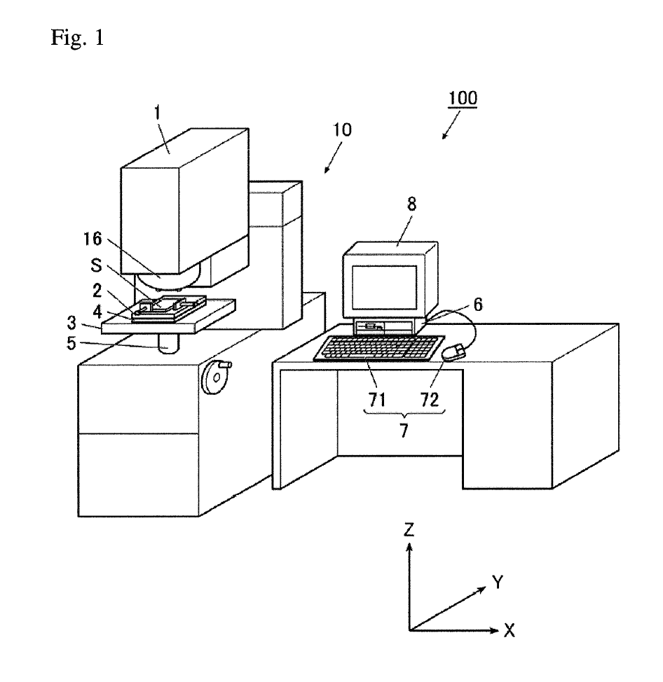

Hereafter, details of an embodiment of the present invention are described with reference to the drawings. Moreover, in the following description, an X direction is defined as a left-right direction, a Y direction is defined as a front-back direction, and a Z direction is defined as an up-down direction in FIG. 1. In addition, an X-Y plane is defined as a horizontal plane.

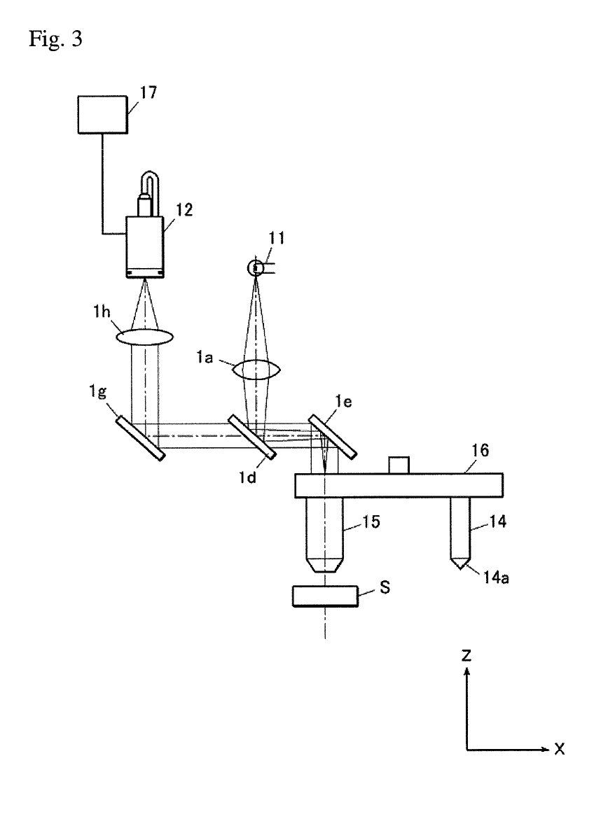

A hardness tester 100 is a Vickers hardness tester, for example, that includes an indenter 14a (see FIG. 3) having a rectangular planar shape. As shown in FIGS. 1 to 4, the hardness tester 100 is configured with a hardness tester main body 10, a controller 6, an operator 7, a monitor 8, and a data obtainer 9.

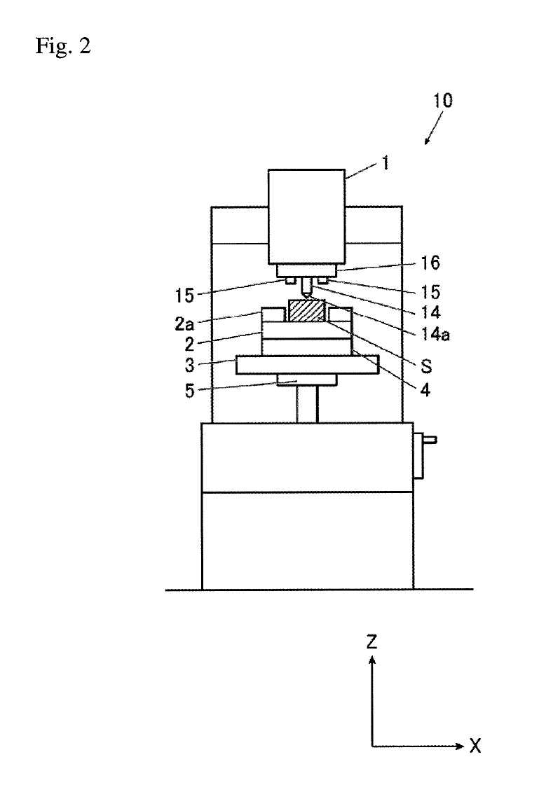

As shown in FIG. 2, the tester main body 10 includes a hardness measurer 1 measuring hardness of a sample S; a sample stage 2 on which the sample S is placed; an XY stage 3 displacing the sample stage 2; an AF stage 4 for focusing on a surface of the sample S; and an elevator mechanism 5 raising and lowering the sample stage 2 (the XY stage 3 and the AF stage 4).

As shown in FIG. 3, the hardness measurer 1 is configured with an illuminating device 11 illuminating the surface of the sample S; a CCD camera 12 capturing an image of the surface of the sample S; and a turret 16. The turret 16 includes an indenter column 14, which includes the indenter 14a, and a field lens 15. The turret 16 is capable of switching between the indenter column 14 and the field lens 15 by rotating.

The illuminating device 11 shines a light to illuminate the surface of the sample S. The light shone by the illuminating device 11 reaches the surface of the sample S via a lens 1a, a half mirror 1d, a mirror 1e, and the field lens 15.

Based on reflected light input from the surface of the sample S via the field lens 15, the mirror 1e, the half mirror 1d, a mirror 1g, and a lens 1h, the CCD camera 12 obtains image data by capturing an image of the surface of the sample S as well as the indentation formed in the surface of the sample S by the indenter 14a. The CCD camera 12 outputs to the controller 6 the obtained image data via a frame grabber 17 that is capable of simultaneously accumulating and storing image data having a plurality of frames. Thus, the CCD camera 12 is an image capturer in the present invention.

The indenter column 14 is displaced toward the sample S placed on the sample stage 2 by a load mechanism (not shown in the drawings), which is driven in response to a control signal output by the controller 6. The indenter 14a, provided on a forefront end of the indenter column 14, is pressed against the surface of the sample S with a predetermined test force. The present embodiment uses a quadrangular pyramidal Vickers indenter (with opposing angles of 136±0.5°).

The field lens 15 is a collective lens, each lens being configured with a different magnification. A plurality of the field lenses 15 are retained on a bottom surface of the turret 16. The field lenses 15 are arranged above the sample S by rotating the turret 16. Thereby, the light shone by the illuminating device 11 uniformly illuminates the surface of the sample S.

The turret 16 is configured so as to enable the indenter column 14 and the plurality of field lenses 15 to be attached to the bottom surface thereof. The turret 16 is also configured to be capable of arranging any one of the indenter column 14 and the plurality of field lenses 15 above the sample S by rotating the turret 16 around a Z-axis direction. Specifically, the indentation can be formed in the surface of the sample S by arranging the indenter column 14 above the sample S, and the formed indentation can be observed by arranging the field lenses 15 above the sample S.

The sample S is placed on an upper surface of the sample stage 2 and is fixed in place with a sample holder 2a. The XY stage 3 is driven by a drive mechanism (not shown in the drawings) driven in response to the control signal output by the controller 6. The XY stage 3 then displaces the sample stage 2 in a direction (X and Y directions) perpendicular to the displacement direction (Z direction) of the indenter 14a. The AF stage 4 is driven in response to the control signal output by the controller 6. The AF stage 4 then minutely raises and lowers the sample stage 2 based on the image data captured by the CCD camera 12 to focus on the surface of the sample S. The elevator mechanism 5 is driven in response to the control signal output by the controller 6. The elevator mechanism 5 then changes a relative distance between the sample stage 2 and the field lens 15 by displacing the sample stage 2 (the XY stage 3 and the AF stage 4) in the Z direction.

The operator 7 is configured with a keyboard 71 and a mouse 72. The operator 7 receives an operation input by the user during a hardness test. In addition, when a predetermined user input operation is received by the operator 7, a predetermined operation signal corresponding to the input operation is generated and output to the controller 6. Specifically, the operator 7 receives the user's operation to select conditions determining a focus position of the indentation. The operator 7 also receives the user's operation to designate a range of displacement (a range of relative distance between the sample stage 2 and the field lens 15) of the sample stage 2 (the elevator mechanism 5 and the AF stage 4). In addition, the operator 7 receives the user's operation to input a test condition value when carrying out the hardness test with the hardness tester 100. The input test condition value is sent to the controller 6. Herein, the test condition value is a value such as a material of the sample S, a test force (N) loaded on the sample S by the indenter 14a, or a magnification power of the field lens 15, for example. In addition, the operator 7 receives the user's operation to select one of a manual mode, in which the focus position of the indentation is manually determined, and an automatic mode, in which the determination is made automatically. Moreover, the operator 7 receives the user's operation to program a test position when carrying out the hardness test.

The monitor 8 is configured with a display device such as an LCD, for example. The monitor 8 displays, for example, settings for the hardness test input on the operator 7, results of the hardness test, and an image captured by the CCD camera 12 of the surface of the sample S and the indentation formed in the surface of the sample S. Thus, the monitor 8 is a display in the present invention.

The data obtainer 9 is an interface that performs transmission and reception of various data (video signal and audio signal, for example) with an external device. Examples of the data obtainer 9 include, for example, a USB, HDMI, Bluetooth, wired LAN, wireless LAN, and the like. The data obtainer 9 obtains, for example, sample shape data that can specify the shape of the sample S. The sample shape data is, for example, vector data or bitmap data prepared by CAD (Computer Aided Design). The sample shape data is obtained from, for example, a magnetic or optical recording medium such as a CD-ROM (Compact Disk ROM) or DVD-ROM (Digital Versatile Disc ROM) detachably mounted in the data obtainer 9, a server connected via wireless communication, and the like. Thus, the data obtainer is a data obtaining component of the present invention.

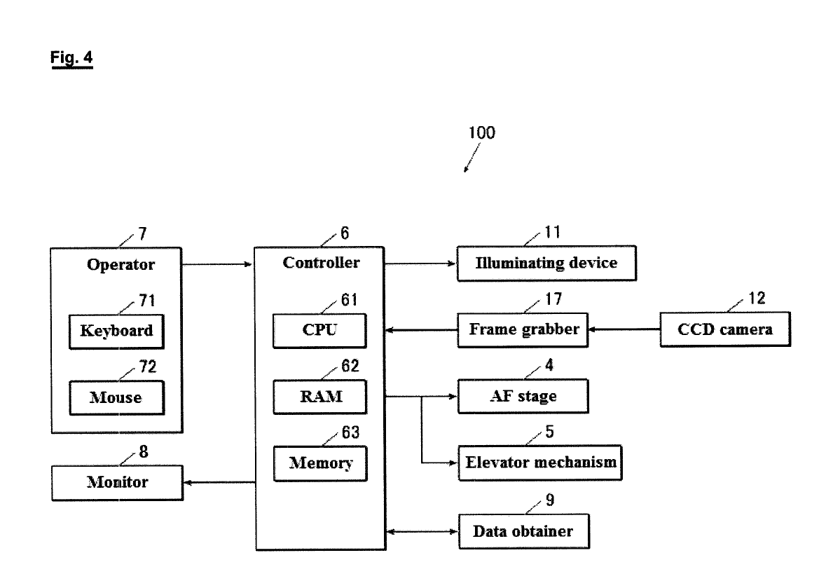

As shown in FIG. 4, the controller 6 is configured to include a CPU 61, a RAM 62, and a memory 63. The controller 6 performs operation control for performance of a predetermined hardness test by executing a predetermined program stored in the memory 63.

The CPU 61 retrieves a processing program stored in the memory 63, then opens and executes the processing program in the RAM 62. The CPU 61 thus performs overall control of the hardness tester 100. The RAM 62 opens the processing program executed by the CPU 61 in a program storage region within the RAM 62 and stores, in a data storage region, input data and processing results generated when the processing program is executed. The memory 63 includes, for example, a recording medium (not shown in the drawings) storing a program, data, and the like. The recording medium is configured with a semiconductor memory and the like. In addition, the memory 63 stores various kinds of data, various kinds of processing programs, and data processed by running the processing programs that allow the CPU 61 to perform overall control of the hardness tester 100. Moreover, the memory 63 stores the sample shape data obtained by the data obtainer 9.

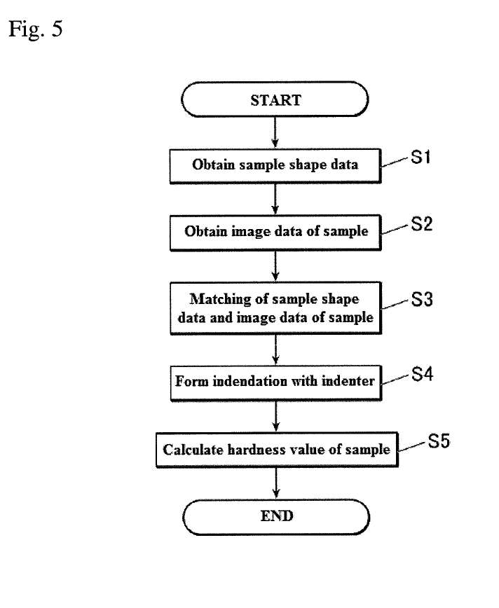

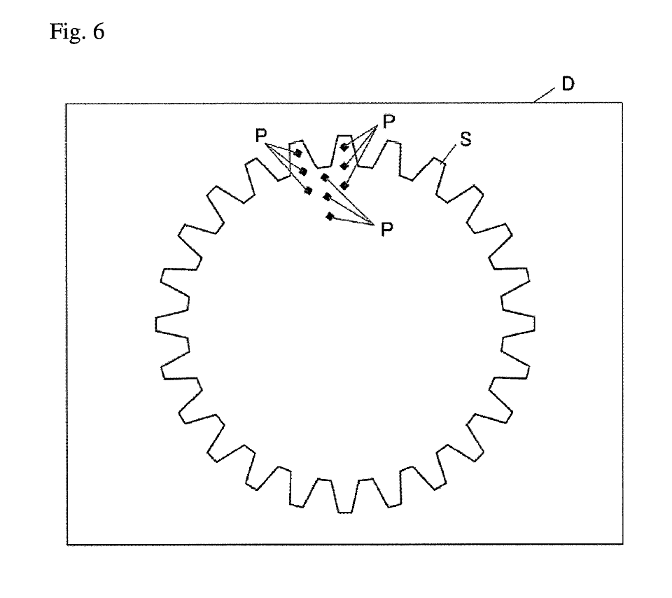

Next, operations of the hardness tester 100 according to the present embodiment are described with reference to the flow chart of FIG. 5. First, sample shape data D1 is obtained (step S1: data obtainment). Specifically, the CPU 61 controls the data obtainer 9 so that the data obtainer 9 obtains the sample shape data D1 of the sample S, which is subjected to the hardness test. The sample shape data D1 obtained in step S1 is shape data including a contour of the entire sample S and enables determinations to be made for the inside and the outside of the sample S. Further, in the present embodiment, as shown in FIG. 6, test positions P, . . . are programmed on the sample shape data D1 by a user in advance.

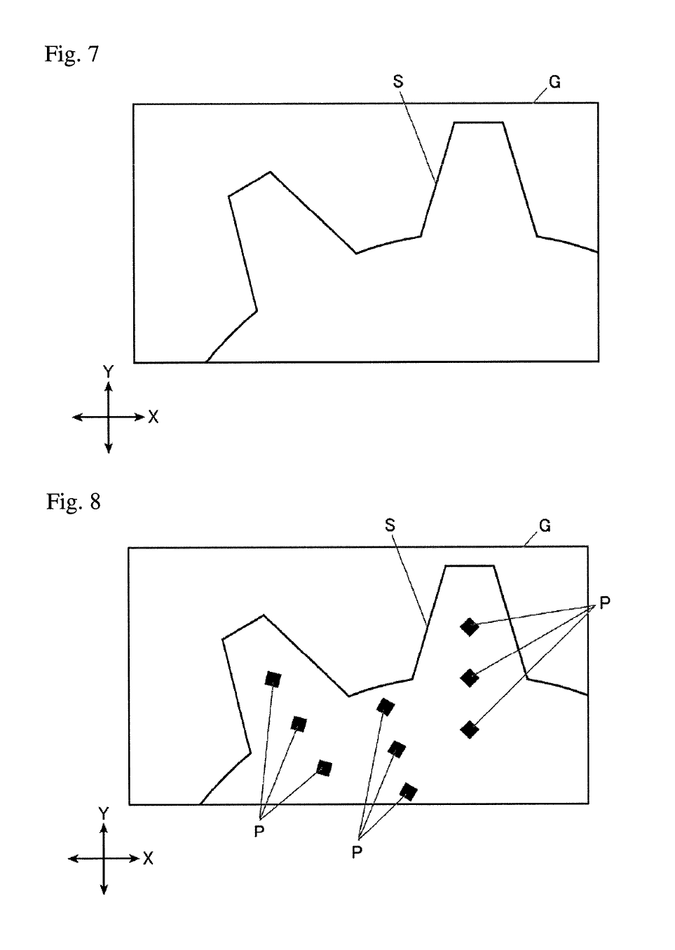

Next, image data D2 of the sample S is obtained (step S2: image capturing). Specifically, when the field lens 15 has been positioned above the sample S by rotating the turret 16, first the CPU 61 displaces the XY stage 3 so as to position a predetermined area on the surface of the sample S directly beneath the field lens 15. Next, the CPU 61 raises and lowers the AF stage 4 to perform automatic focusing on the surface of the sample S based on the image data obtained by the CCD camera 12. Then, in a state where automatic focusing is performed on the surface of the sample S, the CPU 61 captures an image of the surface of the sample S with the CCD camera 12 to obtain the image data D2 of the sample S. The CPU 61 displays an image G of the surface of the sample S on the monitor 8 based on the obtained image data D2 of the sample S (see FIG. 7). Specifically, the CPU 61 is an image capture controller of the present invention controlling the CCD camera 12 to capture an image of the surface of the sample S and obtain the image data D2 of the sample S. Further, the CPU 61 is a display controller of the present invention displaying the image G of the surface of the sample S on the monitor 8 based on the image data D2 of the sample S captured by the CCD camera 12.

Next, a matching process is performed between the sample shape data D1 and the image data D2 of the sample S (step S3: matching). Specifically, the CPU 61 performs matching that associates the sample shape data D1 obtained in step S1 with the image data D2 of the sample S obtained in step S2. In the present embodiment, as shown in FIG. 7, only a portion of the image data D2 of the sample S is obtained due to a field of view of the field lens 15. Accordingly, matching is performed by comparing the obtained portion of image data with the contour of the sample S included in the sample shape data D1 and appropriately correcting differences in X and Y directions and a rotation direction. Thereby, as shown in FIG. 8, the test positions set on the sample shape data D1 are displayed on the monitor 8 overlapped on the image G based on the image data D2 of the sample S. Specifically, the CPU 61 is a matching performer of the present invention associating the sample shape data D1 obtained by the data obtainer 9 with the image data D2 of the sample S obtained by the CCD camera 12. Since this matching enables reference to the sample shape data D1, it becomes possible to understand not only the test positions in a portion of the sample S but in the entire sample S. Thus, hardness testing with respect to the entire sample S becomes possible without obtaining image data of the entire sample S.

Next, an indentation is formed (step S4: indentation formation) with the indenter 14a in the test positions P, . . . set on the sample shape data D1. Specifically, first, the CPU 61 moves the sample S (sample stage 2) by referring to the test positions on the sample shape data D1 so that a predetermined test position (test starting point for an initial cycle) is placed in a position opposite to the indenter 14a. The CPU 61 then forms an indentation in the test position with the indenter 14a. Thus, the CPU 61 is an indentation former of the present invention creating indentations in the test positions P, . . . set on the sample shape data D1 with the indenter 14a after the sample shape data D1 and the image data D2 of the sample S have been associated in step S3.

Next, a hardness value of the sample S is calculated (step S5: hardness value calculation). Specifically, when the field lens 15 has been positioned above the sample S by rotating the turret 16, the CPU 61 captures an image of the surface of the sample S with the CCD camera 12 to obtain image data. The CPU 61 then analyzes the image data of the surface of the sample S output from the CCD camera 12 to measure the length of the diagonal lines of the indentation formed in the surface of the sample S. Then, the CPU 61 calculates the hardness value of the sample S based on the measured length of the diagonal lines. Thus, the CPU 61 is a hardness value calculator of the present invention calculating the hardness value of the sample S based on the indentation captured with the CCD camera 12 after the indentation has been formed in step S4.

As described above, the hardness tester 100 according to the present embodiment includes the data obtainer 9 obtaining the sample shape data D1 capable of specifying the shape of the sample S, the image capture controller (CPU 61) controlling the CCD camera 12 to capture an image of the surface of the sample S and obtain the image data D2 of the sample S, the matching performer (CPU 61) associating the sample shape data D1 obtained by the data obtainer 9 with the image data D2 of the sample S obtained by the CCD camera 12, the indentation former (CPU 61) forming an indentation with the indenter 14a in the test positions P, . . . set on the sample shape data D1 after the sample shape data D1 is associated with the image data D2 of the sample S by the matching performer, and the hardness value calculator (CPU 61) calculating the hardness value of the sample S based on the indentation, the image of which is captured by the CCD camera 12 after the indentation is formed by the indentation former. Thus, according to the hardness tester 100 of the present embodiment, the sample shape data D1 capable of specifying the shape of the sample S can be obtained and used, and thus the sample shape data D1 prepared before the testing can be effectively utilized, enabling an efficient hardness test.

Further, according to the hardness tester 100 of the present embodiment, the sample shape data D1 capable of specifying the shape of the sample S can be obtained and used, and thus it is possible to automatically determine the inside and outside of the sample S. Therefore, it is possible to prevent hardness testing from being performed in a position beyond the range of the sample S.

Moreover, according to the hardness tester 100 of the present embodiment, the sample shape data D1 on which the test positions P, . . . are programmed by the user in advance can be loaded to form an indentation in the test positions P, . . . set on the sample shape data D1.Therefore, it becomes possible to reduce setup for a hardness test and to more efficiently perform the hardness test.

In addition, the hardness tester 100 according to the present embodiment further includes the display controller (CPU 61) displaying on the monitor 8 the image G of the surface of the sample S based on the image data D2 of the sample S obtained by the CCD camera 12. Thus, the image G and the like after matching can be displayed, and the user can visually identify the test positions P, . . . overlapped and displayed on the image G.

Above, a concrete description was given based on the embodiment according to the present invention. However, the present invention is not limited to the above-described embodiment and may be modified without departing from the scope of the invention.

For example, in the above-described embodiment, after the sample shape data D1 is obtained in step S1 in FIG. 5, the image data D2 of the sample S is obtained in step S2. However, the present invention is not limited to this. For example, after the image data D2 of the sample S is obtained in step S1, the sample shape data D1 may be obtained in step S2.

In addition, the test positions P, . . . are programmed on the sample shape data D1 in advance by the user in the above-described embodiment. However, the present invention is not limited to this. For example, when the test positions P, . . . are not yet programmed on the sample shape data D1 in step S1 in FIG. 5, after the sample shape data D1 is obtained, the sample shape data D1 may be displayed on the monitor 8 to program the test positions P, . . . on the sample shape data D1 via the operator 7. In this case, the operator 7 is a test position setter of the present invention setting the test positions P, . . . on the sample shape data D1 obtained by the data obtainer 9. By programming the test positions P, . . . on the sample shape data D1, programming can be performed on a clearer image without unnecessary patterning, scratches, and the like, as compared to a conventional case in which the test positions P, . . . are programmed on the image data D2 of the sample S.

Moreover, in the above-described embodiment, the monitor 8 displayed the image G of the surface of the sample S based on the image data D2 of the sample S and the image G after matching the sample shape data D1 with the image data D2 of the sample S. However, the present invention is not limited to this. For example, a configuration is possible in which the monitor 8 is not included and the above-described image G and the like is not displayed. Moreover, in the above-described embodiment, the monitor 8 displays the contour of the sample S and the programmed test (planned) positions P, . . . ; however, the present invention is not limited to this. For example, in addition to the above displays, a test execution position, a hardness value, a hardness distribution contour map, or test results such as a color or colored band according to hardness may be displayed based on an indentation captured by the CCD camera 12 and the hardness value of the sample S calculated by the hardness value calculator. With the monitor 8 displaying the test results as describe above, the test results can be reported to the user in a detailed and easy to understand manner.

Moreover, in the above-described invention, the matching process is performed by comparing image data of a portion obtained in step S2 in FIG. 5 with the contour of the sample S included in the sample shape data D1, and by appropriately correcting differences in the X and Y directions and in the rotation direction; however, the present invention is not limited to this. For example, a wide range image capable of showing the entire sample S may be obtained and compared to the sample shape data D1 to perform the matching process. In addition, even when the sample shape data D1 is shape data showing the contour not of the entire sample S but of only a portion of the sample S, the matching process can be performed by comparing the sample shape data D1 with image data of the obtained portion or the wide range image and by making appropriate corrections. Furthermore, a jig may be set on the sample stage 2 in advance so that the sample S is placed in a position where the obtained image data D2 of the sample S automatically matches with the sample shape data D1. In addition, the matching process may employ any method as long as matching between the sample shape data D1 and the image data D2 of the sample S is possible.

In addition, modifications may also be made as needed to detailed structures and operations of each component configuring the hardness tester 100 without departing from the scope of the invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A hardness tester for measuring hardness of a sample by forming an indentation in a surface of the sample by loading a predetermined test force on an indenter and measuring a dimension of the indentation, the hardness tester comprising:
a data obtainer configured to obtain sample shape data that can specify a shape of the sample;
an image capture controller configured to control an image capturer to capture an image of the surface of the sample and further configured to obtain image data of the sample;
a matching performer configured to associate the sample shape data obtained by the data obtainer with the image data of the sample obtained by the image capturer;
an indentation former configured to form the indentation with the indenter in a test position set on the sample shape data after the sample shape data and the image data of the sample have been associated by the matching performer; and
a hardness value calculator configured to calculate a hardness value of the sample based on the indentation captured with the image capturer after the indentation has been formed by the indentation former.

2. The hardness tester according to claim 1, further comprising a display controller configured to display the image of the surface of the sample on a display, based on the image data of the sample obtained by the image capturer.

3. The hardness tester according to claim 2, wherein the display controller is further configured to display test results on the display, based on the indentation captured by the image capturer and the hardness value of the sample calculated by the hardness value calculator.

4. The hardness tester according to claim 2, further comprising a test position setter configured to set the test position on the sample shape data obtained by the data obtainer.

5. The hardness tester according to claim 3, further comprising a test position setter configured to set the test position on the sample shape data obtained by the data obtainer.

6. A method for a hardness test in a hardness tester measuring hardness of a sample by forming an indentation in a surface of the sample by loading a predetermined test force on an indenter and measuring a dimension of the indentation, the method comprising:
data obtainment obtaining sample shape data that can specify a shape of the sample;
image capture controlling an image capturer to capture an image of the surface of the sample and obtaining image data of the sample;
matching associating the sample shape data obtained in said data obtainment with the image data of the sample obtained in said image capture;
forming the indentation with the indenter in a test position set on the sample shape data after the sample shape data and the image data of the sample have been associated in said matching; and
calculating a hardness value of the sample based on the indentation captured with the image capturer after the indentation has been formed in said forming the indentation.
